(19) United States
(12) Patent Application Publication
(10) Pub. No.: US 2017/0241444 A1
(43) Pub. Date: Aug. 24, 2017

(54) JET PUMP AND DIFFUSER EXTENSION SLEEVE OF SAME

(71) Applicant: KABUSHIKI KAISHA TOSHIBA, Minato-Ku (JP)

(72) Inventors: Masanobu WATANABE, Yokohama (JP); Hajime MORI, Yokohama (JP); Hiroyuki ADACHI, Machida (JP); Tadahiro MITSUHASHI, Yokohama (JP); Daiki TAKEYAMA, Yokohama (JP)

(73) Assignee: KABUSHIKI KAISHA TOSHIBA, Minato-Ku (JP)

(21) Appl. No.: 15/432,447

(22) Filed: Feb. 14, 2017

(30) Foreign Application Priority Data
Feb. 18, 2016 (JP) 2016-029179

(51) Int. Cl. F04F 5/46; G21C 15/25; F04F 5/24

(52) U.S. Cl. CPC F04F 5/463; F04F 5/24; G21C 15/25

(57) ABSTRACT

A diffuser extension sleeve 40 includes: a fixer 41 fixed to an upper portion of a diffuser in which an edge of an inlet mixer 25 is inserted, the inlet mixer 25 guiding circulating water, which is transported from a recirculating pump by pressure, downward along an inner surface of a reactor pressure vessel; a spacer 42 having a lower portion inserted in a gap defined by an outer surface 25a of the inlet mixer and an inner surface 26a of the diffuser; and a support 43 supporting the spacer 42 from the fixer 41 side and guiding movement of the spacer 42 in a longitudinal direction of the inlet mixer 25.

### CROSS-REFERENCE TO RELATED APPLICATIONS

This application is based upon and claims the benefit of priority from Japanese Patient application No. 2016-029179, filed on Feb. 18, 2016, the entire contents of each of which are incorporated herein by reference.

### BACKGROUND OF THE INVENTION

1. Field of the Invention

An embodiment of the present invention relates to a jet pump provided to a boiling-water reactor and a diffuser extension sleeve of the same.

2. Description of the Related Art

A boiling-water reactor is provided with a recirculating system that controls the flow rate of water passing the reactor core (the reactor core flow rate) by forced circulation of water in the pressure vessel so as to adjust the power output of the reactor.

This recirculating system includes a jet pump disposed in the pressure vessel and a recirculating loop for ejecting water in the pressure vessel, pressurizing the water with a recirculating pump, and supplying the water to the jet pump.

For existing nuclear power plants, increasing the reactor core flow rate is under consideration for the extension of the upper limit of the rated power output.

Increasing the reactor core flow rate may lead to an increase in the flow rate of water leaking from a gap between slip joints of the jet pump and result in what is called self-induced vibration, which is vibration with a large amplitude.

In the case of occurrence of self-induced vibration in the jet pump, components of the jet pump may be worn, or a support for the jet pump may be broken.

The jet pump is initially designed to prevent such self-induced vibration in use within the rated power output.

However, operation beyond a predetermined rated power output or in an unexpected mode is required in some cases and self-induced vibration should be prevented even in such a case.

To meet this challenge, a technique (see Japanese Patent Laid-Open No. 2014-199243) has been disclosed in which an extension sleeve is added to the upper portion of a diffuser of a jet pump to control the flow rate of water leaking from a gap between slip joints and thus suppress self-induced vibration.

### SUMMARY OF THE INVENTION

To design the above-described extension sleeve, it is required to grasp the shape of a gap path between slip joints of an existing jet pump, that is, the precise insertion depth of an inlet mixer pipe into the diffuser.

However, in some plants, a large design tolerance is set for the insertion depth and a large difference may exist between an insertion depth in a design drawing and the actual insertion depth; therefore, to additionally provide an extension sleeve, the states of the slip joints should be revealed by an advance survey and a long-term process is needed.

An embodiment of the present invention have been made in consideration of such circumstances, and it is therefore an object of the embodiments to provides a jet pump and a diffuser extension sleeve of the same which allow adjustment of the size of a gap formed between slip joints after the installation.

A diffuser extension sleeve for a jet pump according to an embodiment of the present invention, including: a fixer fixed to an upper portion of a diffuser in which an edge of an inlet mixer is inserted, the inlet mixer guiding circulating water, which is transported from a recirculating pump by pressure, downward along an inner surface of a reactor pressure vessel; a spacer having a lower portion inserted in a gap defined by an outer surface of the inlet mixer and an inner surface of the diffuser; and a support supporting the spacer from the fixer side and guiding movement of the spacer in a longitudinal direction of the inlet mixer.

A jet pump comprising according to an embodiment of the present invention, including: an inlet mixer guiding circulating water, which is transported from a recirculating pump by pressure, downward along an inner surface of a reactor pressure vessel; a diffuser in which an edge of the inlet mixer is inserted; and a diffuser extension sleeve installed on an upper portion of the diffuser, wherein the diffuser extension sleeve includes: a fixer fixed to the upper portion of the diffuser; a spacer having a lower portion inserted in a gap defined by an outer surface of the inlet mixer and an inner surface of the diffuser; and a support supporting the spacer from the fixer side and guiding movement of the spacer in a longitudinal direction of the inlet mixer.

An embodiment of the present invention provides a jet pump and a diffuser extension sleeve of the same which allow adjustment of the size of a gap formed between slip joints after the installation.

### BRIEF DESCRIPTION OF THE DRAWINGS

FIG. 1 is a longitudinal sectional view of a boiling-water reactor;

FIG. 2 is an oblique view of a jet pump provided to the boiling-water reactor;

FIG. 3 is a longitudinal sectional view of slip joints of the jet pump;

FIG. 4A is a partial longitudinal sectional view of a diffuser extension sleeve according to a first embodiment of the present invention, and FIG. 4B is a side view of the same;

FIG. 5A is a partial longitudinal sectional view of a diffuser extension sleeve according to a first modification of the first embodiment, and FIG. 5B is a side view of the same;

FIG. 6A is an external view of a diffuser extension sleeve according to a second modification of the first embodiment in a separated state before mounting, and FIG. 6B is an external view of the finished assembly after mounting;

FIG. 7A is a partial longitudinal sectional view of a diffuser extension sleeve according to a second embodiment, FIG. 7B is a partial longitudinal sectional view of a diffuser extension sleeve according to a third embodiment, FIG. 7C is a partial longitudinal sectional view of a diffuser extension sleeve according to a fourth embodiment, and FIG. 7D is a partial enlarged view of FIG. 7C; and

FIG. 8 is a graph showing the effects of the diffuser extension sleeves according to the embodiments.

### DETAILED DESCRIPTION OF THE PREFERRED EMBODIMENTS

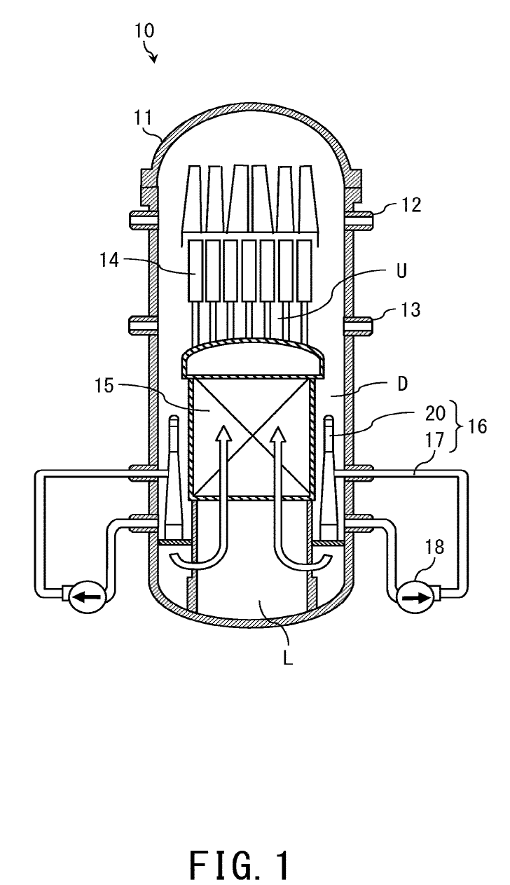

An embodiment of the present invention will now be described with reference to the attached drawings. Before the description of the embodiments, a boiling-water reactor will be described referring to FIG. 1.

A boiling-water reactor 10 includes a reactor core 15 that heats water held in a pressure vessel 11, a steam-water separator 14 that separates the heated water into steam and liquid water, a steam outlet 12 that guides separated steam to a turbine (not shown in the drawing), a feedwater inlet 13 that returns feedwater generated by cooling and condensing expanded steam after work in the turbine, to the pressure vessel 11, and a recirculating system 16 that circulates a mixture of water resulting from steam-water separation and returned feedwater.

The recirculating system 16 includes a jet pump 20 disposed inside the pressure vessel 11, and a recirculating loop 17 for ejecting water in the pressure vessel 11, pressurizing the water with a recirculating pump 18, and supplying the water to the jet pump 20.

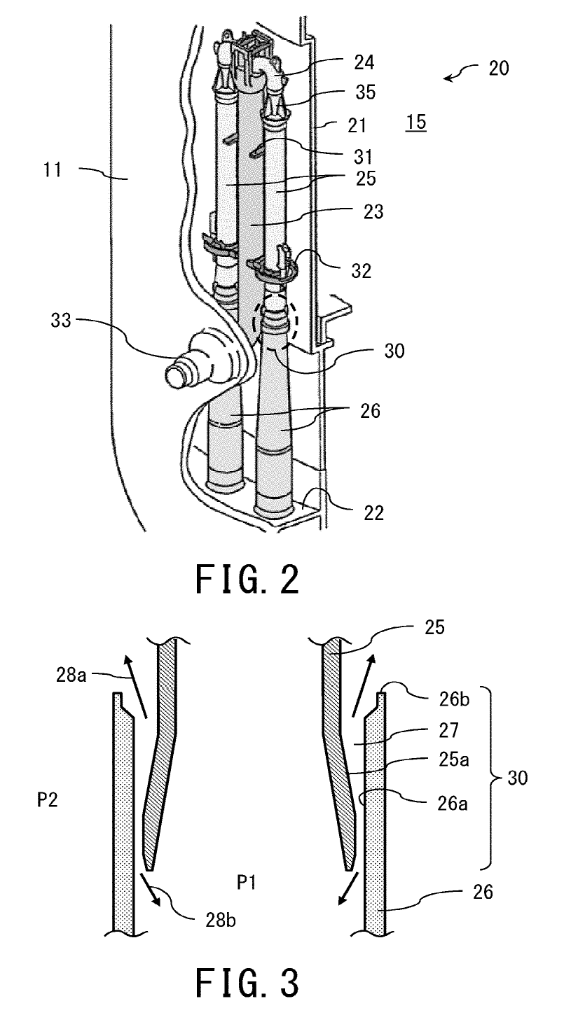

FIG. 2 illustrates the structure of the jet pump 20. The jet pump 20 mainly includes a riser pipe 23 fixed with a riser brace 31 fixed to the inner surface of the pressure vessel 11 by welding, two elbow members 24 branching and bending from the riser pipe 23 and having nozzle members 35 at the ends, inlet mixers 25 supported by a riser bracket 32 fixed to the riser pipe 23, and diffusers 26 supported by an annular shroud support plate 22 at the bottom.

The recirculating loop 17 in which water is pressurized by the recirculating pump 18 (FIG. 1) and circulated is joined to the riser pipe 23 through a water inlet 33 provided to the pressure vessel 11.

Water rising in the riser pipe 23 passes through the elbow members 24 so that its travel direction is reversed, then is mixed with water around the nozzle members 35, and then flows into the inlet mixers 25. Water passing through the inlet mixers 25 passes through the diffusers 26 and then is ejected from the openings at the ends of the diffusers 26. The travel direction of water ejected from the openings at the ends of the diffusers 26 is reversed at the bottom of the pressure vessel 11 so that the water rises inside of the reactor core 15.

As shown in FIG. 3, the bottoms of the inlet mixers 25 are inserted in the tops of the diffusers 26, thereby forming slip joints 30.

A gap is provided between the slip joints 30 to absorb thermal expansion or ensure a margin for adjustment during the installation. A gap formed between the outer surface 25a of the inlet mixer 25 and the inner surface 26a of the diffuser includes a tapered region 27 which is tapered downward from the top rim 26b of the diffuser.

Pressure from the recirculating pump 18 (FIG. 1) produces a difference between the internal pressure P1 and external pressure P2 of the diffuser 26 (|P1−P2|>0) and leakage flows 28a and 28b leak from the gap.

When the pressure difference (P1−P2) is greater than 0, the leakage flow 28a occurs and travels in the forward direction from the diffuser 26 to the outside. When the pressure difference (P1−P2) is less than 0, the leakage flow 28b occurs and travels in the reverse direction to the inside of the diffuser 26.

When the flow rates of the leakage flows 28a and 28b from the gap exceed limits, the state may become unstable and vibration having a large amplitude called self-induced vibration may occur.

In this case, the occurrence of self-induced vibration is suppressed depending on the shape of the gap path. For example, a spacer is inserted in the tapered region 27 of the slip joint 30 to provide a gap path in such a shape.

An example shape of the gap path preferred for suppressing the occurrence of self-induced vibration is a shape tapered upward of the gap path, that is, a flow path shape tapered in the forward direction downstream of the leakage flow 28a, which reduces the risk of self-induced vibration due to the leakage flow 28a. To reduce the risk of self-induced vibration under any of the leakage flows 28a and 28b, the gap path should have a portion with a certain width and length.

### First Embodiment

### (Configuration)

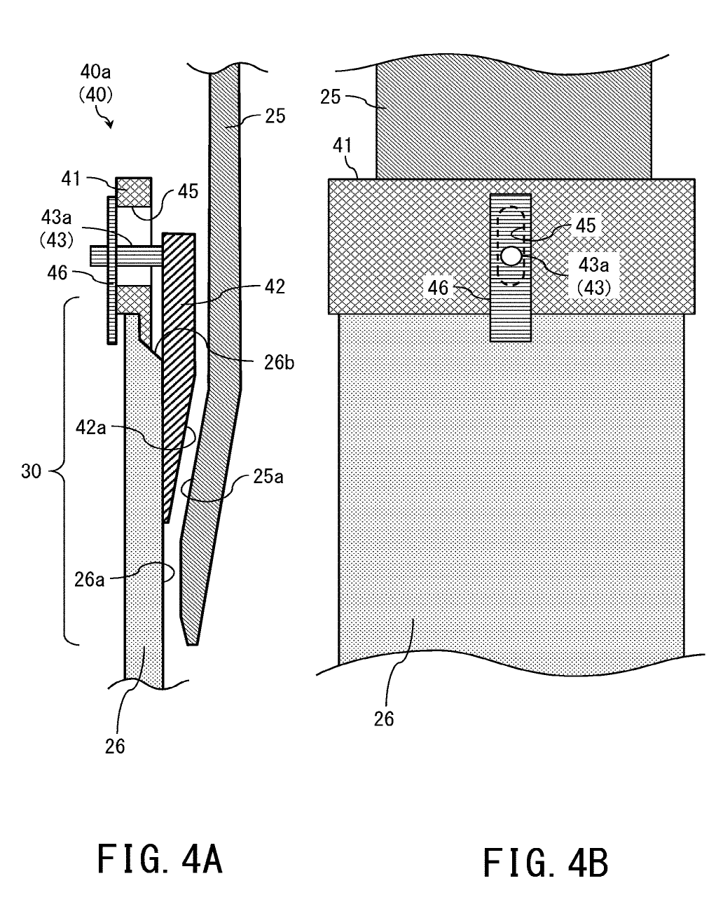

FIG. 4A is a partial longitudinal sectional view of a diffuser extension sleeve 40a according to a first embodiment (hereinafter simply referred to as “extension sleeve 40a”), and FIG. 4B is a side view of the same.

This diffuser extension sleeve 40a includes a fixer 41, a spacer 42, and supports 43.

The fixer 41 has a ring shape having the same cross section as the diffuser 26.

The fixer 41 is fixed to the top rim 26b of the diffuser 26 in which an edge of the inlet mixer 25 is inserted and the mixer 25 guides circulating water, which is transported from the recirculating pump 18 (see FIG. 1) by pressure, downward along the inner surface of the pressure vessel 11.

The fixer 41 may be fixed to the top rim 26b of the diffuser by, but not exclusively, welding, threading, and any other common method such as using a fastener.

The spacer 42 has a ring shape with an outside diameter that can be inserted in the hollow space of the diffuser 26.

This spacer 42 is disposed in a space defined by the outer surface 25a of the inlet mixer and the inner surface 26a of the diffuser to adjust the size of the space.

The insertion depth of the inlet mixer 25 in the slip joint 30 varies within a design tolerance.

The shape of the spacer 42 according to each embodiment is not limited to a particular shape although a tapered shape similar to the gap path of the slip joint 30 has been taken as its example. The spacer 42 may have any shape with which the size of the space varies with movement in the vertical direction.

The supports 43 according to the first embodiment are pin members 43a which are fixed to the spacer 42 at the base and pass through guide holes 45 formed at the fixer, the guide holes 45 ensures a space in which the pin members 43a can vertically move.

These supports 43 (the pin members 43a) support the spacer 42 from the fixer 41 side and guide the spacer 42 in the longitudinal direction of the inlet mixer 25.

It should be noted that a plurality of pin members 43a and guide holes 45 is provided at regular intervals around the fixer 41.

A lockup member 46 secures a head of the pin member 43a passing through the guide hole 45 and the fixer 41 to fix the vertical position of the spacer 42.

### (Operation)

Positioning of the spacer 42 will now be described. Until the extension sleeve 40a is mounted on the top rim 26b of the diffuser, the limitation by the lockup member 46 is loosened so that the spacer 42 can vertically move freely. Hence, when the extension sleeve 40a is mounted, the inner surface 42a of the spacer 42 comes in contact with the outer surface 25a of the inlet mixer. In this state, the spacer 42 is moved upward and fixed by the pin member 43a such that a preferred shape of the gap path is obtained.

A gap between the inner surface 42a and the outer surface 25a which can provide a preferred shape of the gap path can be determined from design information on the inlet mixer 25. Accordingly, the upward travel distance of the spacer 42 from the state where it is in contact with the inlet mixer 25 can be predicted.

It is preferable that the extension sleeve 40a be designed such that the spacer 42 comes in contact with the inlet mixer 25 within its movable range, considering the design tolerance of the insertion depth of the inlet mixer 25 into the diffuser 26.

Alternatively, it may be designed such that the spacer 42 forms a preferred shape of the gap path when the spacer 42 is in the lowest position with the maximum insertion depth of the inlet mixer 25 considering the design tolerance. In other words, the extension sleeve 40a is designed such that the lowest position of the spacer 42 is optimal with the maximum insertion depth of the inlet mixer 25 within the design tolerance.

In this case, positioning is performed in the above manner if the spacer 42 comes in contact with the inlet mixer 25 during the installation and if the spacer 42 does not come in contact with the inlet mixer 25 in the lowest position, the spacer 42 is fixed in that position.

Positioning of the spacer 42 may be performed in any other process. For example, an instrument or jig for measuring the insertion depth of the inlet mixer 25 may be used with the extension sleeve 40a, and positioning of the spacer 42 may be performed according to the measurement.

### (Effects)

In the extension sleeve 40a according to this embodiment, the spacer 42 is vertically moved after mounting on the diffuser 26 and the gap path therefore takes a shape preferred for suppression of self-induced vibration even with variations in the actual insertion depth of the inlet mixer 25 resulting from the design tolerance. Accordingly, designing the extension sleeve 40a does not require the calculation of the actual insertion depth of the inlet mixer 25 in advance.

(First modification)

The first modification of the first embodiment in which the lockup member 46 is eliminated will now be described.

In this case, the spacer 42 comes in contact with the outer surface 25a of the inlet mixer when positioned in the lowest position, comes in contact with the support 43 above the guide hole 45 when positioned in the highest position, and does not engage within a predetermined range.

With this structure, the spacer 42 remains in contact with the inlet mixer 25 even during the operation of the nuclear power plant after the installation of the extension sleeve 40a. This can reduce the flow rates of the leakage flows.

At this time, the vertical position of the spacer 42 is flexible and the spacer 42 is therefore pushed up when the inlet mixer 25 or the diffuser 26 is deformed by heat, so that no thermal stress occurs.

(Second modification)

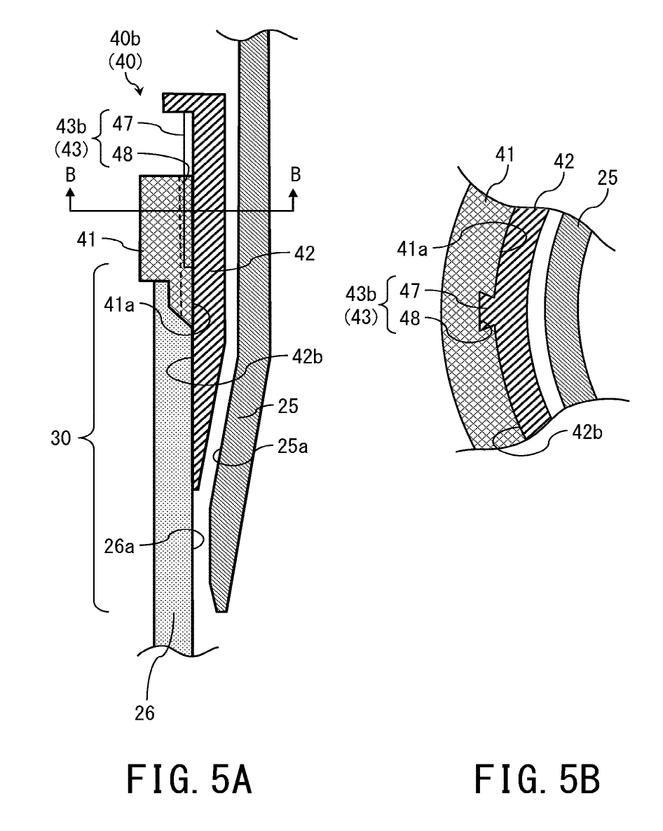

FIG. 5A is a partial longitudinal sectional view of a diffuser extension sleeve 40b according to the second modification of the first embodiment, and FIG. 5B is a cross-sectional view of the same along line B-B. The components in FIGS. 5A and 5B which have the same structure or function as the respective components in FIGS. 4A and 4B are denoted by the same reference numerals as the respective components, and their description will be omitted.

In the extension sleeve 40b according to the second modification, the support 43 includes a projection 47 that is formed on one of the inner surface 41a of the fixer and the outer surface 42b of the spacer, and a guide groove 48 that is formed on the other of the inner surface 41a of the fixer and the outer surface 42b of the spacer and engages with the projection 47 for guiding in the vertical direction.

The projection 47 and the guide groove 48 engage with each other to prevent the spacer 42 from detaching in the radial direction of the extension sleeve 40b. The projection 47 has a flare shape when viewed from the vertical axis in FIGS. 5A and 5B, but may have any other shape such as a T or cross shape instead. Alternatively, a plurality of projections 47 and guide grooves 48 is provided such that one projection 47 projects in one direction oblique to the radial direction of the extension sleeve 40b and another projection 47 projects in the opposite direction oblique to the radial direction, so that a plurality of projections 47 prevents the spacer 42 from detaching from the extension sleeve 40b.

Note that FIGS. 5A and 5B show the case where the projection 47 is formed on the outer surface 42b of the spacer, and the guide groove 48 is formed on the inner surface 41a of the fixer.

With this structure, the spacer 42 comes in contact with the outer surface 25a of the inlet mixer in the lowest position and is freely movable in a vertical direction.

In addition, a lockup member for limiting the movement of the spacer 42 may be provided to the fixer 41. For example, with a bolt hole passing through the fixer 41 in a circumferential direction and formed in the position of the guide groove 48, a bolt passed through the bolt hole is threaded pushing a surface of the projection 47, which resides on the outer side in the circumferential direction, after the spacer 42 is positioned at a desired level, so that the movement is limited.

The second modification can provide the same effects as the first embodiment and the first modification of the first embodiment.

### (Separation Structure of Extension Sleeve)

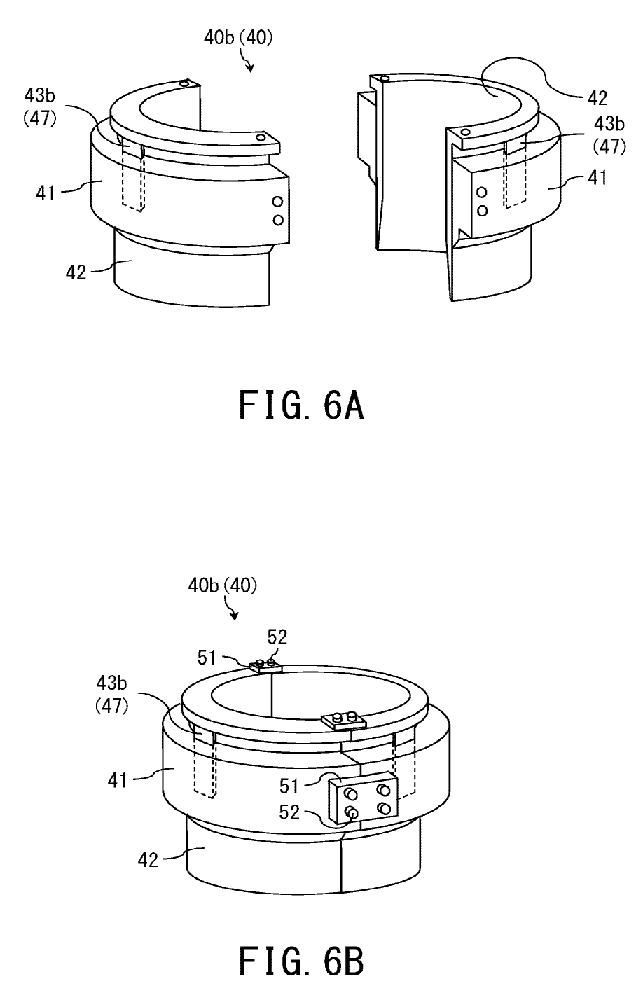

FIGS. 6A and 6B are general oblique views of the extension sleeve 40b according to the second modification of the first embodiment. FIG. 6A shows a separated state before mounting, and FIG. 6B shows a finished assembly after mounting.

The extension sleeve 40 consisting of the fixer 41 and the spacer 42 separated in a horizontal direction in this manner can be installed while the edge of the inlet mixer 25 stays in the diffuser 26.

Separated components of the extension sleeve 40 with the separation structure each have bolt holes in the fixer 41 into which fastening bolts 52 are threaded with a fastening plate 51 therebetween after installation on the upper portion of the diffuser.

To mount the extension sleeve 40 with the separation structure on the jet pump 20 (see FIG. 1), the extension sleeve 40 is separated from the upper portion of the pressure vessel 11 and transferred down to a desired position while being suspended. At this time, the projection 47 and the guide groove 48 having the shapes described above engage with each other and the sleeve 40 does not therefore detach from the fixer 41 or deviate in the circumferential direction.

It should be noted that the separation structure of this extension sleeve is also applicable to the first embodiment, the first modification of the first embodiment, and the embodiments below.

### Second Embodiment

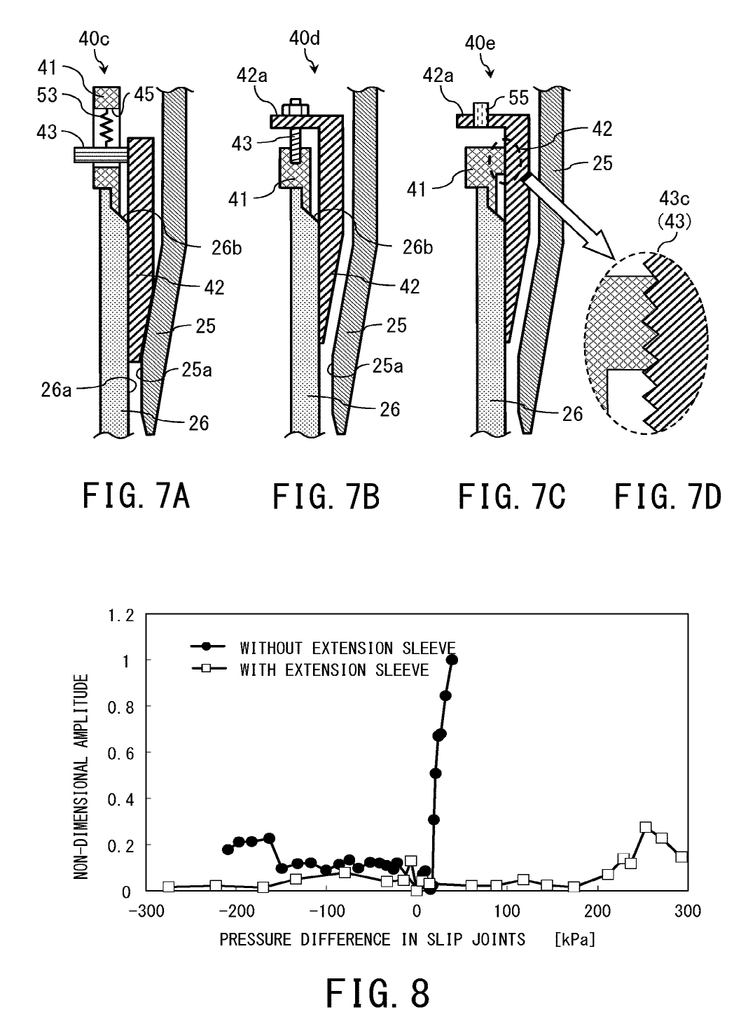

FIG. 7A is a partial longitudinal sectional view of an extension sleeve 40c according to a second embodiment. The components in FIG. 7A which have the same structure or function as the respective components in FIGS. 4A and 4B are denoted by the same reference numerals as the respective components, and their description will be omitted.

The extension sleeve 40c according to the second embodiment further includes an elastic member 53 having one end in contact with the fixer 41 and the other end in contact with at least one of the spacer 42 and the support 43 and then providing a vertical urging force.

FIG. 7A shows the case where the other end of the elastic member 53 is fixed to the support 43. Alternatively, the top portion of the fixer 41 may be extended to above the spacer 42 and the other end of the elastic member 53 may be fixed to the spacer 42.

In this embodiment, which provides the same effects as the above embodiment, the expansion of the gap path due to the leakage flow 28a is suppressed by the urging force from the elastic member 53, and when the spacer 42 is in contact with the inlet mixer 25, the urging force from the elastic member 53 increases structural damping, thereby reducing the risk of the occurrence of self-induced vibration.

Note that the existing jet pump is deformed with time in some degree. For this reason, even when the above-described spacer 42 is in contact with the inlet mixer 25, it is probably out of contact with the inlet mixer 25 at some circumferential directions. However, if they are partially in contact, the urging force from the elastic member 53 increases structural damping and no impact is made on the formation of the shape of a flow path resistant to self-induced vibration. In other words, the spacer 42 does not need to be in contact with the inlet mixer 25 in 360 degrees.

### Third Embodiment

FIG. 7B is a partial longitudinal sectional view of an extension sleeve 40d according to a third embodiment. The components in FIG. 7B which have the same structure or function as the respective components in FIGS. 4A and 4B are denoted by the same reference numerals as the respective components, and their description will be omitted.

In the extension sleeve 40d according to the third embodiment, the support 43 is a screw 43b passing through a flange 42c, which is disposed on the top of the spacer 42, and fixed by the fixer 41 at the tip. Here, the screw 43b may be either a bolt or a combination of a bolt and a nut.

With this structure, the size of the gap can be adjusted by rotating the screw 43b.

This embodiment can provide the same effects as the first embodiment.

### Fourth Embodiment

FIG. 7C is a partial longitudinal sectional view of an extension sleeve 40e according to a fourth embodiment, and FIG. 7D is a partial enlarged view of the same. The components in FIGS. 7C and 7D which have the same structure or function as the respective components in FIGS. 4A and 4B are denoted by the same reference numerals as the respective components, and their description will be omitted.

In the extension sleeve 40e according to the fourth embodiment, the support 43 is screw slots 43c formed along an interface between the inner surface of the fixer 41 and the outer surface of the spacer 42.

With this structure, the size of the gap can be adjusted by rotating the spacer 42.

Further, a displacement sensor 55 is provided to the flange 42c on the top of the spacer 42. The insertion depth of the inlet mixer 25 into the diffuser 26 and the size of the gap can be obtained from the data detected by the displacement sensor 55.

Effects of the diffuser extension sleeves according to the embodiments will now be described referring to the graph of FIG. 8. In this graph, the horizontal axis indicates the difference between the external pressure P1 and the internal pressure P2 of the diffuser (P1−P2), and the vertical axis indicates the amplitude of self-induced vibration normalized with the width of the gap path.

The graph shows the results with and without the extension sleeve 40.

The range in which the difference is a positive value indicates the condition in which the leakage flow 28a (see FIG. 3) in the forward direction occurs, and the range in which the difference is a negative value indicates the condition in which the leakage flow 28b in the reverse direction occurs.

This graph demonstrates that a steep rise of the amplitude and the occurrence of vibration with a large amplitude are observed when the leakage flow 28a in the forward direction occurs without the extension sleeve 40. In contrast, suppression of vibration is observed when both the leakage flow 28a in the forward direction and the leakage flow 28b in the reverse direction occur with the extension sleeve 40.

With the diffuser extension sleeve according to at least one of the above-described embodiments, the position of the spacer can be adjusted after the installation on the diffuser and the gap between the slip joints of the existing jet pump can be adjusted to a desired size independently of variations in design tolerance.

Some embodiments of the present invention described above are illustrative only and do not limit the scope of the invention. These embodiments can be implemented in other various modes, and various omissions, replacements, modifications, and combinations can be made without departing from the gist of the invention. These embodiments and modifications are included in the scope and spirit of the invention and in the claims and equivalents.

What is claimed is:

1. A diffuser extension sleeve for a jet pump, comprising:
a fixer that fixed to an upper portion of a diffuser in which an edge of an inlet mixer is inserted, the inlet mixer guiding circulating water, which is transported from a recirculating pump by pressure, downward along an inner surface of a reactor pressure vessel;
a spacer that having a lower portion inserted in a gap defined by an outer surface of the inlet mixer and an inner surface of the diffuser; and
a support that supporting the spacer from the fixer side and guiding movement of the spacer in a longitudinal direction of the inlet mixer.

2. The diffuser extension sleeve for a jet pump according to claim 1, wherein the support configured to a pin member having a base fixed to the spacer and passing through a guide hole formed at the fixer, the guide hole ensures a space in which the pin can vertically move.

3. The diffuser extension sleeve for a jet pump according to claim 2, further comprising a lockup member securing the fixer and a head of the pin member passing through the guide hole.

4. The diffuser extension sleeve for a jet pump according to claim 1, wherein the support configured to:
a projection on one of an inner surface of the fixer and an outer surface of the spacer; and
a guide groove on the other of the inner surface of the fixer and the outer surface of the spacer, the guide groove engaging with the projection for guiding in a vertical direction.

5. The diffuser extension sleeve for a jet pump according to claim 1, further comprising an elastic member having one end in contact with the fixer and the other end in contact with at least one of the spacer and the support, and providing a vertical urging force.

6. The diffuser extension sleeve for a jet pump according to claim 1, wherein the support configured to a screw that passes through a flange on the top of the spacer and is fixed by the fixer at the tip.

7. The diffuser extension sleeve for a jet pump according to claim 1, wherein the support configured to screw slots formed along an interface between an inner surface of the fixer and an outer surface of the spacer.

8. A jet pump comprising:
an inlet mixer guiding circulating water, which is transported from a recirculating pump by pressure, downward along an inner surface of a reactor pressure vessel;
a diffuser in which an edge of the inlet mixer is inserted; and
a diffuser extension sleeve installed on an upper portion of the diffuser, wherein
the diffuser extension sleeve includes: a fixer fixed to the upper portion of the diffuser; a spacer having a lower portion inserted in a gap defined by an outer surface of the inlet mixer and an inner surface of the diffuser; and a support supporting the spacer from the fixer side and guiding movement of the spacer in a longitudinal direction of the inlet mixer.
